(19) United States
(12) Patent Application Publication
(10) Pub. No.: US 2023/0417916 A1
(43) Pub. Date: Dec. 28, 2023

(54) DATA MANAGEMENT OF A BUILDING CONSTRUCTION OVER TIME

(71) Applicant: SPACE TIME S.A., Luxembourg (LU)

(72) Inventor: Shahriar AGAAJANI, Luxembourg (LU)

(21) Appl. No.: 18/247,361

(22) PCT Filed: Sep. 30, 2021
(86) PCT No.: PCT/EP2021/077002

§ 371 Date: Mar. 30, 2023

(30) Foreign Application Priority Data
Sep. 30, 2020 (LU) LU 102102

(51) Int. Cl. G01S 17/89; G01S 17/42; G01S 7/481

(52) U.S. Cl. CPC G01S 17/89; G01S 17/42; G01S 7/4817

(57) ABSTRACT

A method of data management of the construction of a building, comprising the following steps: (a) optically 3D scanning the building with a laser scanner so as to obtain 3D data of the building; (b) storing the 3D data; (c) iterating steps (a) and (b) at different points in time T₁, T₂, T₃, T₄, Tₙ; and (d) formatting the 3D data obtained at the different points in time T₁, T₂, T₃, T₄, Tₙ so as to display the 3D data with a point of time selector enabling, upon selection, to display the 3D data at any of the different points in time T₁, T₂, T₃, T₄, Tₙ.

### CROSS-REFERENCE TO RELATED APPLICATIONS

The present invention is the US national stage under 35 U.S.C. § 371 of International Application No. PCT/EP2021/077002 which was filed on Sep. 30, 2021, and which claims the priority of application LU102102 filed on Sep. 30, 2020 the contents of which (text, drawings and claims) are incorporated here by reference in its entirety.

### FIELD

The invention is directed to the field of building construction and more particularly to the management of a building construction.

### BACKGROUND

Nowadays, buildings are designed by means of computer programs, in particular using Building Information Models (BIMs). However, the construction steps remain standard in that the various steps are mainly made manually and also supervised by supervisors. It is known that hand workers and also supervisors managing them do not necessary follow strictly the plans of the building, for various reasons. It follows that elements of the building with regard to their position and/or number differ from what the plan foresees. Also, certain elements like electrical cables and water piping embedded in plaster and in concrete screed do not need to be placed at specific locations provided that they are properly embedded and interconnected at determined locations of the building. It is current to take pictures of such cables and piping once installed but before applying plaster or pouring a screed onto them. However, pictures, even in electronic format, get lost and if not anyway provide a limited information about their exact position, e.g., when it comes afterwards to drilling holes close to them due to technical constraints.

Prior art patent document published KR 10 1392566 discloses a method of managing quality of a building using a 3D laser scanner and a computer device. The 3D data obtained of a particular building member of the building under construction is merged with a 3D CAD model and a deviation is calculated, enabling determining whether the building member is be reconstructed or replaced.

Prior art patent document published JP 2002-21329 discloses, similarly to the preceding reference, a method of managing quality of a building using a 3D laser scanner. The method provides that the acquired 3D data are compared with the original design data in order to detect and record possible shifts in position of the various construction elements of the building.

The use of a 3D scanner for supervising and managing a building under construction is known also from the patent documents published JP 2005-213972 A and JP 2012-3435 A.

However, shortcomings remains, in particular when renovation or adaptions works are considered a certain time after termination of the construction of the building, i.e. when the exact position of certain embedded nor more visible elements is needed. This is also the case when constructions defects are observed and the responsibility of each company involved in the construction of the building is potentially engaged.

### SUMMARY

The invention has for technical problem to overcome at least one of the drawbacks of the above cited prior art. More specifically, the invention has for technical problem to provide a data management of the construction of a building that provides access to data of the several construction stages, in particular after termination of the construction of the building, where the data provides useful, accurate and exploitable information about the different components and elements of the building as built.

The invention is directed to a method of data management of the construction of a building, comprising the following steps: (a) optically 3D scanning the building with a laser scanner so as to obtain 3D data of the building; (b) storing the 3D data; (c) iterating steps (a) and (b) at different points in time; wherein the method comprises the additional step: (d) formatting the 3D data obtained at the different points in time so as to display said 3D data with a point of time selector enabling, upon selection, to display the 3D data at any of the different points in time.

Advantageously, the selection of the point of time among the different points in time applies to the display of the 3D data of the whole building. It can then be navigated geographically in the building through the display of the 3D data for each of the selected point of time. Also, it can be navigated during time in the building through the display of the 3D data selectively at the different points in time.

According to an exemplary embodiment, the different points in time correspond to different stages of the construction of the building.

According to an exemplary embodiment, among the stages of the construction of the building, each stage differs from a preceding stage in that additional equipment or construction material of the building is mounted or applied.

According to an exemplary embodiment, step (d) further comprises characterizing at least one object in the 3D data for each point in time by assigning a name and a geometry to each of the at least one object.

According to an exemplary embodiment, the at least one object corresponds to an equipment mounted to the building or a unit of construction material applied to the building.

According to an exemplary embodiment, at step (d) the at least one object is characterized such that by selecting the at least one object with a pointer on the display the name, position and/or dimensions thereof are displayed.

According to an exemplary embodiment, at step (d) each of the characterized at least one object is compared with a Building Information Model BIM of the object stored in a project of the building.

According to an exemplary embodiment, the method further comprises a step: (e) comparing the at least one characterized object with the corresponding BIM of the object and outputting a compliance note of the object.

According to an exemplary embodiment, step (a) is carried out at different points in time according to step (c) by positioning the laser scanner at the same place relative to the building under construction or by correcting the obtained 3D data so as to compensate for a different place where the laser scanner is positioned.

According to an exemplary embodiment, steps (a), (b), (c) and (d) are carried out at different sites in the building under construction.

According to an exemplary embodiment, step (d) comprises producing a set of files enabling a user to display the building under construction at any of the different points in time by selecting the point in time at the point of time selector.

According to an exemplary embodiment, the set of files produced at step (d) enable to selectively display each of the sites of the building under construction.

Advantageously, the set of files is produced at step (d) so as to enable displaying the building under construction at any of the different points in time at a display device in connection with inertial sensors of the display device so as to automatically change the point of view depending on the orientation of the display device. Such a display device is advantageously a tablet pc.

Advantageously, the set of files is produced at step (d) so as to enable displaying the building under construction selectively in different preselected areas of the building.

According to an exemplary embodiment, at step (d) the point of time selector is located at the bottom of the displayed 3D data.

The invention is particularly interesting in that it provides a powerful tool for recording and providing useful technical data of a building about various stages of its construction.

### DRAWINGS

FIG. 1 is a schematic representation of a building under construction which is scanned according to various embodiments of the invention.

FIG. 2 is a flowchart illustrating the main steps of the method of data management of the construction of a building, according to various embodiments of the invention.

FIG. 3 illustrates in a schematic way three stages of the construction of the building of FIG. 1 and the resulting display of the scanned 3D data according to various embodiments of the invention.

FIG. 4 is a detailed view of the display of information of characterized elements the building according to various embodiments of the invention.

### DETAILED DESCRIPTION

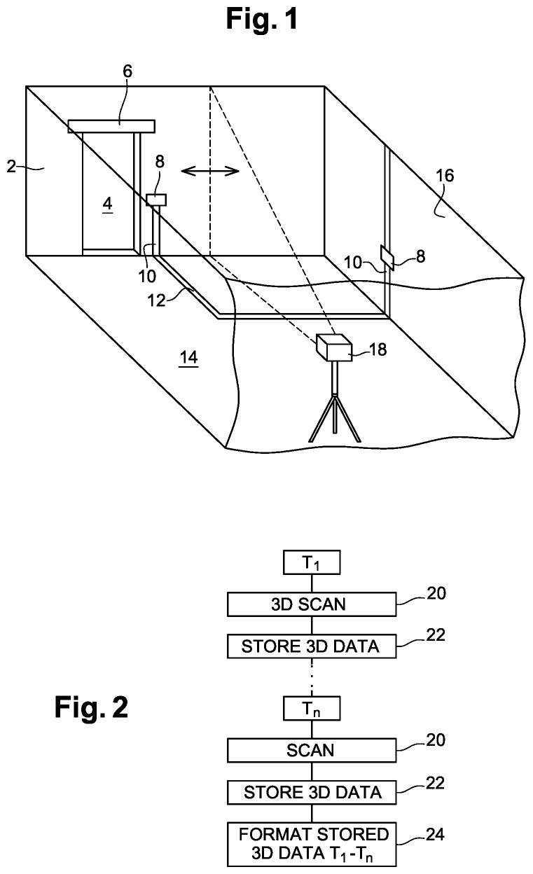

FIG. 1 shows schematically and in perspective a room in a building that is under construction and that is scanned for obtaining and storing 3D data of that room at that specific stage of construction.

As this is apparent, the room comprises a first wall 2 with an opening 4 for a door. The wall is made of blocks or bricks, of concrete or any other common or suitable material like plaster, assembled together in a staggered arrangement. A lintel 6 is therefore provided at the top of the opening 4 for properly supporting the blocks or bricks above the opening 4. In the wall 24 next to the opening 4 a cavity is formed for receiving an electric box 8 that will support a switch. A vertical groove is formed in the wall 2 directly below the electric box 8 for installing wall tubing 10 receiving electric cables. That tubing extends further with floor tubing 12 over the floor 14, for instance over a concrete slab until the other wall 16 where another cavity is formed for receiving also an electric box connected to the floor tubing with the wall tubing 10 extending vertically in the wall 16. Once the electric boxes 8 and the tubing 10 and 12 is properly installed, the walls 2 and 16, made of assembles blocks, can be covered with plaster and the concrete slab can be covered with a concrete screed. It is understood that once a layer of plaster is applied to the walls, the lintel 6 and the tubing 10 and 12 will not be visible anymore. This means that their type, dimensions and/or positions cannot be controlled anymore unless by destructively removing the plaster and screed. Detectors designed for detecting the presence of electrical cables below a plaster layer exist but provide local and approximate information.

This is a schematic and simplified illustration of a construction stage of a building under construction, being understood that this by no means limits the invention.

A 3D scanner 18 is positioned in the room so as to be able to scan the walls 2 and 16 and the floor 14. In general manner, the scanner is active and of the non-contact type, i.e., emits some kind of radiation or light and detect its reflection or radiation passing through object in order to probe an object or environment. Possible types of emissions used include light, ultrasound or x-ray. Advantageously, the 3D scanner emits laser light with a cone-like field of view, and like cameras, can only collect information about surfaces that are not obscured. While a camera collects colour information about surfaces within its field of view, a 3D scanner collects distance information about surfaces within its field of view. The laser is used to emit a pulse of light and the amount of time before the reflected light is seen by a detector is measured. Since the speed of light is known, the round-trip time determines the travel distance of the light, which is twice the distance between the scanner and the surface. The “picture” produced by the 3D scanner describes the distance to a surface at each point in the picture. This allows the three dimensional position of each point in the picture to be identified. The above technology is as such well-known and commercially available.

FIG. 2 is a flowchart illustrating the main steps of data management of the construction of a building, according to the invention. At a time T₁ corresponding to a stage 1 of the construction of a building, the building is optically 3D scanned as step 20 and the 3D data obtained is stored as a step 22. At a time T₂ corresponding to a stage 2 of the construction of the building, steps 20 and 22 are repeated, i.e., the building is optically 3D scanned and the 3D data obtained is stored. The differently, the steps 20 and 22 are repeated as several points in time T₁, T₂, . . . Tₙ. After steps 20 and 22 at the point of time Tₙ, the stored 3D data of the same building at the different points of time T₁, T₂, . . . Tₙ are formatted and compiled together so as to be displayed to a user at any of the points of time T₁, T₂, . . . Tₙ by an appropriate selection by the user.

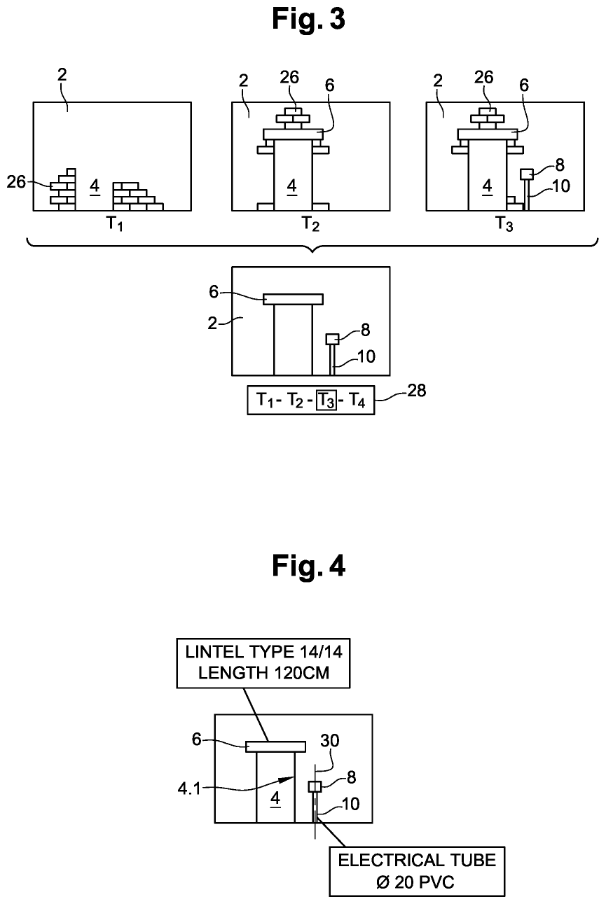

FIG. 3 is a schematic illustration of 3 stages of construction of the building of FIG. 1, for instance at the points of time T₁, T₂, T₃ and T₄.

At stage 1 at point of time T₁, the blocks 26 are being assembled together in a staggered arrangement for forming the wall 2 while forming the opening 4.

At stage 2 at point of time T₂, the lintel 6 has been placed on the blocks 26 at the top of the opening 4 and further blocks 26 have been placed on the lintel 6 so as to finish the wall 2.

At stage 3 at point of time T₃, a cavity has been formed in the wall 2, at the side of the opening 4 and an electrical box 8 has been placed therein. Also a vertical groove has been formed in the wall 2 below the electrical box 8 and electrical tubing 10 has been placed therein.

At a further not illustrated stage 4 at point of time T₄, the wall 2 will be totally covered with a layer of plaster, so that the blocks 26, the lintel 6 and the electrical wall tubing 10 will not be visible anymore, and this in principle as long as the plaster is not removed.

At each of the stages 1 to 4, a 3D scanner 18 as in FIG. 1 has been used for scanning the wall 2 and obtaining 3D data. These data have been stored separately and thereafter merged and formatted for displaying the wall 2 selectively at the different stages 1 to 4 by selecting the point of time T₁, T₂, T₃ or T₄. For instance, in FIG. 3, the wall at stage 3 corresponding to the point of time T₃ is displayed, showing the lintel 6 and the electrical wall tubing 10 whereas in reality the layer of plaster has already been applied at stage 4.

The display of the 3D data as images in FIG. 3 comprises a selector 28 of the point of time Tₙ. This selector can take various forms like a slider, a drop down menu or the like.

Advantageously, the 3D data obtained at each step of optical 3D scanning are put into register so that when navigating in time, the reference objects or shapes, like for instance the opening 4 in FIGS. 1 and 3, remain at the same position on the display. This provides an increased comfort of consultation of the history of construction of the building but this is not mandatory. A slight shift between the 3D data images at the different points in time is indeed acceptable.

FIG. 4 illustrates the formatted 3D data as in FIG. 3 where, additionally, some of the construction elements have been characterized. For instance during the formatting step 24 in FIG. 2, the lintel 6 has been characterized in that it is considered as an object or element, delimited by its outer contour and to which a name and characteristics are associated like the type of lintel, for instance and in a purely exemplary manner, a 14/14 cm concrete lintel with a length of 120 cm. This information is electronically stored with the 3D data and is available when selecting the element on the 3D image data. Additional information can be associated like a definition of its contour and its position. Similarly, the electrical wall tubing 10 can be characterized by the type of tube like PVC with a diameter of 20 mm. Also the longitudinal axis 30 thereof can be defined so that any distance therefrom can be easily calculated by selecting the axis and any other element or point the area. For example, the distance between the inner vertical face 4.1 of the opening 4 and the longitudinal axis 30 of the electrical tubing 10 can be easily obtained by selecting each of them on the display and activating a distance tool calculating the distance there between.

This characterization of construction element or material is in principle made manually or partly manually when formatting the 3D data obtained by the optical 3D scanning. This can be partly automated by specific computer routines that detect such elements and readily suggests a characterization, e.g., based on the shape and/or dimensions. An operator carrying out the formatting of the 3D data can then accept as is, reject or modify such suggestions. He can also characterize objects that might not have been automatically detected by the routine.

The characterization of the elements can be compared with the design data. More specifically, it is nowadays common to use Building Information Models or BIMs, i.e., files (often but not always in proprietary formats and containing proprietary data) containing a digital representation of physical and functional characteristics of a facility and which can be extracted, exchanged or networked to support decision-making regarding a built asset. I practise, BIMs are taken out of a library of available models for various standard or at least current objects like beams, pipes, concrete elements, etc.

As a matter of example, the lintel 6 in FIG. 4 is characterized in that it is recorded as a lintel of a given type with a defined effective contour. The latter can be compared with the definition of the lintel in the design data, for instance the definition being a BIM. The comparison between the effective contour therefore and the theoretical one can provide an objective indication of conformity of the effective construction with the design data.

With regard to displaying the 3D data as images, as illustrated in FIG. 3, e.g., by selection a point of time Tₙ with the selector 28, the displaying can be on a display device, like a tablet PC, in connection with one or more inertial sensors and/or positioning means of the display device so as to automatically change the point of view of the displayed images depending on the orientation of the display device. This greatly enhances the navigation and experience with the information in that a simple movement of the display device, in particular in the building itself, provides a corresponding change of point of view, i.e. moves the displayed images in accordance with the movement of the display device.

Also, displaying of the building under construction can be in a selected area of the building. Such different areas can be preselected and selectable via buttons or icons on the displayed images. This also greatly enhances the navigation and experience with the information.

The above description is based on a simplistic example of a wall with a door opening and an electrical box adjacent thereto, for the sake of clarity of disclosure of the invention. In reality, a building is more complex than a single room as illustrated here. This means that several files of 3D data obtained by different optical 3D scanning operations might have to be merged for obtaining a continuity of 3D data and images between parts of the building, like walls or rooms. It is also clear that not all 3D data have necessarily to be merged, essentially for distinct sites of a building which do not need to be connected or merged.

1.-13. (canceled)

14. A method of data management of the construction of a building, said method comprising the following steps:
(a) optically 3D scanning the building with a laser scanner so as to obtain 3D data of the building;
(b) storing the 3D data;
(c) iterating steps (a) and (b) at different points in time; and
(d) formatting the 3D data obtained at the different points in time so as to display the 3D data with a point of time selector enabling, upon selection, to display the 3D data at any of the different points in time.

15. The method according to claim 14, wherein the different points in time correspond to different stages of the construction of the building.

16. The method according to claim 15, wherein among the stages of the construction of the building, each stage differs from a preceding stage in that additional equipment or construction material of the building is mounted or applied.

17. The method according to claim 14, wherein step (d) further comprises characterizing at least one object in the 3D data for each point in time by assigning a name and a geometry to each of the at least one object.

18. The method according to claim 17, wherein the at least one object corresponds to an equipment mounted to the building or a unit of construction material applied to the building.

19. The method according to claim 17, wherein at step (d) the at least one object is characterized such that by selecting the at least one object with a pointer on the display the name, position and/or dimensions thereof are displayed.

20. The method according to claim 17, wherein at step (d) each of the characterized at least one object is compared with a Building Information Model BIM of the object stored in a project of the building.

21. The method according to claim 20, further comprising a step:
(e) comparing the at least one characterized object with the corresponding BIM of the object and outputting a compliance note of the object.

22. The method according to claim 14, wherein step (a) is carried out at different points in time according to step (c) by positioning the laser scanner at the same place relative to the building under construction or by correcting the obtained 3D data so as to compensate for a different place where the laser scanner is positioned.

23. The method according to claim 14, wherein steps (a), (b), (c) and (d) are carried out at different sites in the building under construction.

24. The method according to claim 14, wherein step (d) comprises producing a set of files enabling a user to display the building under construction at any of the different points in time by selecting the point in time at the point of time selector.

25. The method according to claim 24 wherein steps (a), (b), (c) and (d) are carried out at different sites in the building under construction, and the set of files produced at step (d) enables to selectively display each of the sites of the building under construction.

26. The method according to claim 14, wherein at step (d) the point of time selector is located at the bottom of the displayed 3D data.
